(19) United States
(12) Patent Application Publication
(10) Pub. No.: US 2006/0259948 A1
(43) Pub. Date: Nov. 16, 2006

(54) Integrated document handling in distributed collaborative applications

(75) Inventors: Thomas Jeffrey Calow, Westford, MA (US); Christoph Luecking, Westford, MA (US); Martin Thomas Moore, Somerville, MA (US); Mary Ellen Zurko, Groton, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/128,074

(22) Filed: May 12, 2005

(51) Int. Cl. H04L 9/00

(52) U.S. Cl. 726/1

(57) ABSTRACT

A method of handling electronic documents can include determining at least one safety parameter of an electronic document and classifying the electronic document based upon the at least one safety parameter. A restriction policy can be selected based upon the classifying step. The selected restriction policy can be implemented for handling the electronic document.

### BACKGROUND

1. Field of the Invention

The present invention relates to document handling within a collaborative software environment.

2. Description of the Related Art

A virus generally refers to a program, or portion of programming code, that replicates itself by being copied or by causing itself to be copied to another program, electronic document, or other computer readable storage medium. Viruses can be transmitted as an attachment to an electronic mail, as part of a downloaded file, or within a diskette or other storage medium. While some viruses are playful in nature, others can be extremely harmful to computer systems, resulting in system crashes and/or data loss. Viruses can be particularly hazardous to shared application data relating to electronic mail systems, document management systems, and the like. Once a system is infected, a virus can easily spread throughout the shared application data.

A virus typically is located within a portion of an electronic document which includes active content. Active content often is a self-contained program, or portion of code, that is executed in some way. Active content automatically executes and accesses a user's computer system to perform one or more tasks. In most cases, active content does not require user permission to execute. Examples of active content can include, but are not limited to, executables, Active X, Visual Basic Scripts, JAVAScript, JAVA, plug-ins, and macros. Accordingly, for a virus to propagate, two general events must occur: (1) the virus is located within an active content portion of an electronic document and (2) the document is executed in such a way that the active content executes.

Conventional antivirus software uses one of several different techniques to defend against system infection. One way is to rely upon a database of virus signatures. The user's computer system is scanned to located any files matching virus signatures in the database. Any files on the scanned portions of the user's system which match one of the known virus signatures can be said to be infected with a virus. The disadvantage of this approach is that before a virus can be recognized and cleaned, the virus first must be discovered, analyzed, and added to the virus signature database. The user's computer system remains vulnerable to attack from a new virus between the time the virus is released until the time the signature of the virus is added to the virus signature database. Such is the case despite a user's best efforts in keeping the virus signature database up-to-date.

Another technique is to identify programs which exhibit suspicious behavior and classify those programs as being infected with a virus. Examples of suspicious behaviors can include, but are not limited to, a program attempting to write data to an executable program or attempting to locate other executables immediately after launch. Identifying anyone of these behaviors can cause antivirus software to classify the offending program as being infected with a virus. This technique is better suited to identifying new viruses than the virus signature approach since there is no reliance upon a database of known virus signatures. Recognition of suspicious behaviors, however, is not foolproof in that false positives do occur. Programs that are not infected, often are mistakenly identified as being infected with a virus.

It would be beneficial to have a way of preventing the spread of viruses within a computer system which overcomes the deficiencies described above.

### SUMMARY OF THE INVENTION

The present invention provides a method and apparatus for handling electronic documents in general, and can be used in conjunction with applications, such as distributed, collaborative applications. One embodiment of the present invention can include a method of handling electronic documents. The method can include determining at least one safety parameter of an electronic document, classifying the electronic document based upon the at least one safety parameter, and selecting a restriction policy based upon the classifying step. The selected restriction policy can be implemented for handling the electronic document.

Another embodiment of the present invention can include a method of handling electronic documents within a collaborative application. The method can include determining at least one safety parameter of an electronic document, classifying the electronic document according to the determining step, and enforcing a security policy based upon a classification of the electronic document.

Yet another embodiment of the present invention can include a machine readable storage being programmed to cause a machine to perform the various steps described herein.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a flow chart illustrating a method of handling electronic documents in accordance with one embodiment of the present invention.

FIG. 2 is a table illustrating classes of documents and associated restrictions in accordance with the inventive arrangements disclosed herein.

FIG. 3 is a pictorial view of a graphical user interface (GUI) configured in accordance with the inventive arrangements disclosed herein.

FIG. 4 is a pictorial view of another GUI configured in accordance with the inventive arrangements disclosed herein.

### DETAILED DESCRIPTION OF THE INVENTION

The present invention provides a solution for document handling within a computer system and, further, can be utilized in the context of distributed, collaborative applications. In accordance with the inventive arrangements disclosed herein, electronic documents (documents) can be classified as belonging to one of several different categories indicating whether the document is considered safe. This classification can focus, at least in part, upon the ability of the document to carry malicious code, whether a virus, a worm, a Trojan horse, spyware, or the like. Other factors such as the file type of the document, whether a security policy exists for the file type, and various attributes of the viewer and/or editor used to launch or execute the document also can be used in the context of classifying the document.

Generally, documents can be classified within an application as being safe, unsafe, or unknown. Different restrictions can be applied to the handling of the document based upon its classification. These restrictions can allow virtually unrestricted handling of safe documents within the application and impose any of a variety of different restrictions to unsafe and/or unknown documents. The range of possible restrictions can include, but is not limited to requiring some sort of affirmative user action prior to executing an unknown document to forbidding the execution of an unsafe document from within the application.

As noted, the present invention can be implemented within the context of a distributed, collaborative application. In one embodiment, a system such one based upon IBM Workplace Collaboration Services, available from International Business Machines Corporation of Armonk, N.Y. can be used. IBM Workplace Collaboration services can provide functions such as electronic mail, calendaring, scheduling, awareness, instant messaging, learning, team spaces, Web-based conferencing, and document and Web content management. The present invention, however, is not to be limited to any particular application as aspects of the inventive arrangements can be used with any of a variety of other software-based systems, particularly those capable of accessing a shared data source. Examples of such systems can include, but are not limited to, electronic mail systems, document management systems, scheduling or calendaring systems, and the like, whether such systems exist independently or are included as part of a larger system.

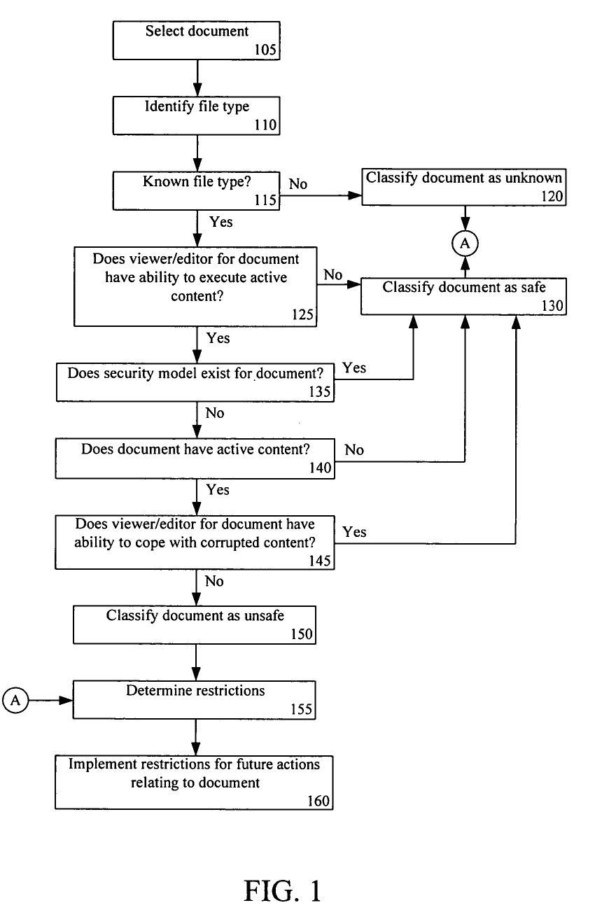

FIG. 1 is a flow chart illustrating a method of handling documents in accordance with one embodiment of the present invention. The method can be implemented by a distributed, collaborative application as described above. Accordingly, a user can access a function such as electronic mail or document management though the system, for example through a client executing within the user's computer system. Beginning in step 105, a document can be selected. The document can be a file stored within a digital library, an attachment to an electronic mail, or the like. While the document can be stored locally on the user's computer system, in another embodiment, the document can be located in a remote data store accessible via a network connection.

In step 110, the file type of the document can be identified. The file type can be determined from a review of the file extension of the document. The document can be identified as a particular type of file according to the extension, i.e. a DOC file, an HTML file, an XML file, or the like. In step 115, a determination can be made as to whether the type of file identified in step 110 is known via a comparison of the determined file type, or extension, with a listing of known file types maintained in the system. If the file type of the document is not known, the method can proceed to step 120, where the document is classified as unknown. If, however, the file type is known, the method can proceed to step 125.

In step 125, a determination can be made as to whether the viewer and/or editor (hereafter collectively “editor”) that is associated with the file type of the document is enabled for, or capable of, executing active content. If the editor is enabled for executing active content, the editor would execute any active content included in the document when the document is rendered or launched. This action would occur despite whether malicious code had attached itself to the active content or the malicious code itself was the active content. If a security model is not in place for the document, execution of the document by the editor would subject the system to risk of infection, particularly as the viewer is usually part of a larger system, whether another application or the operating system itself. An example can include an editor that is capable of displaying electronic mail attachments as part of an electronic mail system. Accordingly, if the editor is able to execute active content, the method can proceed to step 135 for further consideration regarding document handling.

If, however, the editor is not able to execute active content, any malicious code carried by the active content of the document would not be executed by the editor when the document is launched. Rendering the document using the editor within the system would not subject the system to any undue risk as the likelihood of infection is minimized. In that case, the method can proceed to step 130 where the document is classified as being safe.

Continuing with step 135, a further determination can be made as to whether a security model exists for the document. A security model can define information relating to a document that is collected and stored within a system. This information can be linked with permissions that become associated with the document. One example of a security model is having a security policy in place for the document or document type. Another example of a security model can specify that only “safe” operations are to be performed. Safe operations can include, but are not limited to, only displaying content to a screen and not allowing any network operations, or other operations, to files other than the current file or document.

In illustration, a typical security policy can determine information describing the source of a document and/or any active content contained therein. The source refers to the entity that vouches for the safety of the document or code. As an example, a security policy can state that only active content originating from a source such as IBM.com is to be accepted. Here, the source attribute is linked with a permission for executing the active content. In another example, the security policy can be more specific in terms of accepting content only from a particular user or source. In that case, a signature associated with the active content can be used to determine the user, or source, of the code. These are but a few examples of the many different document attributes and permissions that can be implemented as a security model.

In general, a security model is associated with a particular file type and provides instructions for handling that type of file. While each file type that is known by the system can be associated with a security model, this is not always the case. Consequently, it is possible that one or more known file types may not be associated with any security model. In any case, if the document is associated with a security model, the method can proceed to step 130 where the document is classified as safe. If no security model exists for the document, the method can proceed to step 140 to perform further analysis.

In step 140, a determination can be made as to whether the document includes active content. In one embodiment, this determination can be made with reference to the file type of the document. That is, if the file type is one which can include active content, the method can proceed to step 145 despite whether the document actually includes active content. If the file type cannot include active content, the method can proceed to step 130. In illustration, some file types are configured to include active content. It is not uncommon for a word processing document, for example, to contain one or more macros. While a given word processing document need not include a macro, the possibility remains that such a document may include a macro as its format provides for such capability.

In another embodiment, the determination in step 140 can be made with reference to whether the document actually includes active content. That is, the document can be processed to determine whether active content has been included. If it cannot be determined whether the document actually includes active content, the document can be treated as if it does include active content. In that case, the method can proceed to step 145. Despite the particular technique used in step 140, if the document has active content, the method can proceed to step 145. If not, the method can continue to step 130, where the document can be classified as safe. File types that do not include active content and, as such, are considered safe, can have the following extensions: JPG, BMP, GIF, PDF, TXT, SXI, SXC, and SXW. This listing, however, is not intended to be exhaustive, but rather to provide examples of different file types presently considered to be safe.

In step 145, a determination can be made as to whether the editor has the capability of safely processing corrupted content. Editors that are able to handle, or cope with, corrupted content typically include features such as bound checking to ensure that the amount of any data to be written when executing active content will not exceed the size of the destination. Type checking also can be used. It should be appreciated that some programming languages perform bound and type checking automatically. Such is the case with JAVA and meta language, referred to as ML, for example. Thus, editors written in such languages can be considered safe in this regard, i.e. with respect to bound and/or type checking.

This feature set is not intended as an exhaustive listing of safeguards as others also can be included. Still, when implemented within the editor, such safeguards ensure that active code within a document will be restrained. Malicious code will be prevented from overwriting other data or code thereby preventing system crashes or other varieties of system attacks, such as Denial of Service attacks. Thus, if the editor includes proper safeguards, the method can proceed to step 130 where the document is classified as safe. If the editor does not include such safeguards, the method can proceed to step 150 where the document is classified as being unsafe.

In step 155, any restrictions that are to be applied to the handling of the document within the system can be identified. Restrictions can be associated with the different safety classifications. That is, documents classified as safe can be associated with one set of restrictions, while unsafe documents are associated with other restrictions, and unknown documents are associated with still other restrictions. In step 160, the applicable restrictions can be applied to the handling of the document within the system.

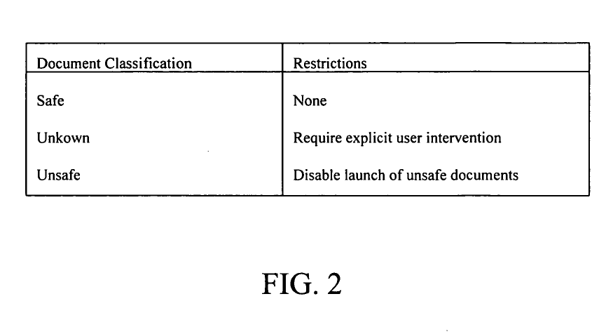

FIG. 2 is a table illustrating classes of documents and associated restrictions in accordance with the inventive arrangements disclosed herein. As shown, the possible document classes include safe, unknown, and unsafe. Each document classification can be associated with 0, 1, or more restrictions. Documents classified as being safe are not associated with any restrictions. Accordingly, users can freely manipulate these documents within the application without any constraints. For example, safe documents can be launched from within the application within an editor, copied, and/or saved.

The unknown document classification has been associated with a restriction that requires explicit user intervention before an action is performed upon an unknown document. Accordingly, prior to performing an action upon an unknown document, the system can notify the user that the selected document is unknown and may carry a virus or harbor malicious code. The notification can ask the user to consider whether the source of the document is a trusted source. The user can be required to acknowledge the warning or notification prior to any user requested action being performed. The notification also can provide the user with an opportunity to cancel the requested action.

The unsafe document classification has been associated with a severe restriction which prevents the launch of any unsafe documents from within the application. Such a restriction may provide the user only with the option of saving the document locally, or outside of the application prior to performing any actions on the document. Thus, the user can be notified that a requested action is unavailable from within the application and that the document must be saved externally. Once saved outside of the system, the user would be permitted to perform any desired action upon the document.

While one or more default restrictions can be defined within the system and associated with different classifications, it should be appreciated that a system administrator also can create custom restrictions and associations of restrictions with the classes. As such, the restrictions discussed with reference to FIG. 2 are provided for purposes of illustration only and should not be viewed as a limitation of the present invention.

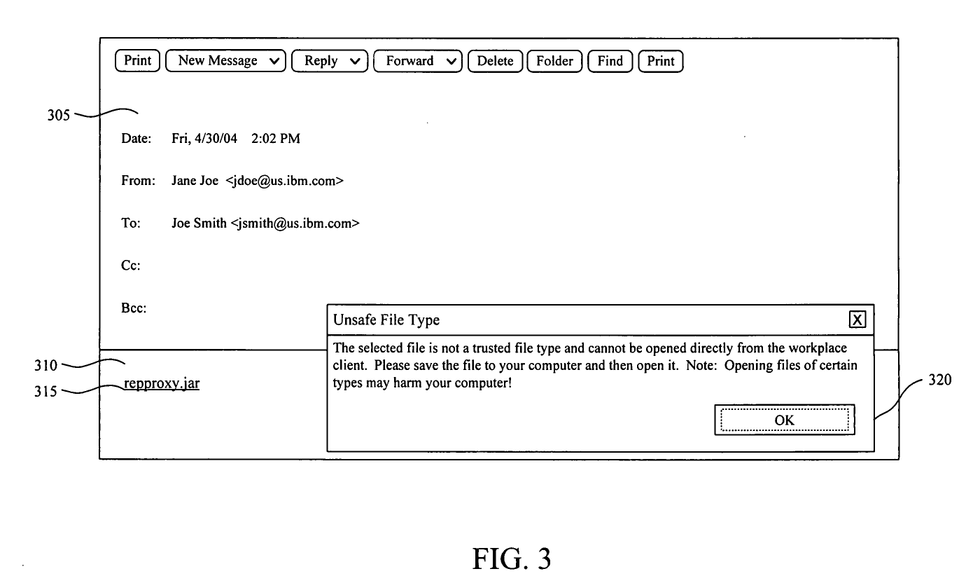

FIG. 3 is a pictorial view of a graphical user interface (GUI) configured in accordance with the inventive arrangements disclosed herein. The GUI can be used with a standalone electronic mail application or with a mail component of a larger distributed, collaborative application. In any case, the GUI can include a window 305 which displays header information for an electronic mail and a window 310 which can display the body and any attachments of an electronic mail.

Link 315 represents an attachment to the electronic mail and has been selected by a user. Link 315 represents a JAR file, which is a JAVA Archive file. A JAR file is a platform-independent file format that can aggregate a plurality of files into one. Multiple JAVA applets and their requisite components, i.e. class files, images, and sounds, can be bundled in a JAR file. Accordingly, the JAR file can include active content and, in this case, has been classified as unsafe. Accordingly, a pop-up style window 320 has been displayed which informs the user of the situation and the applicable restrictions.

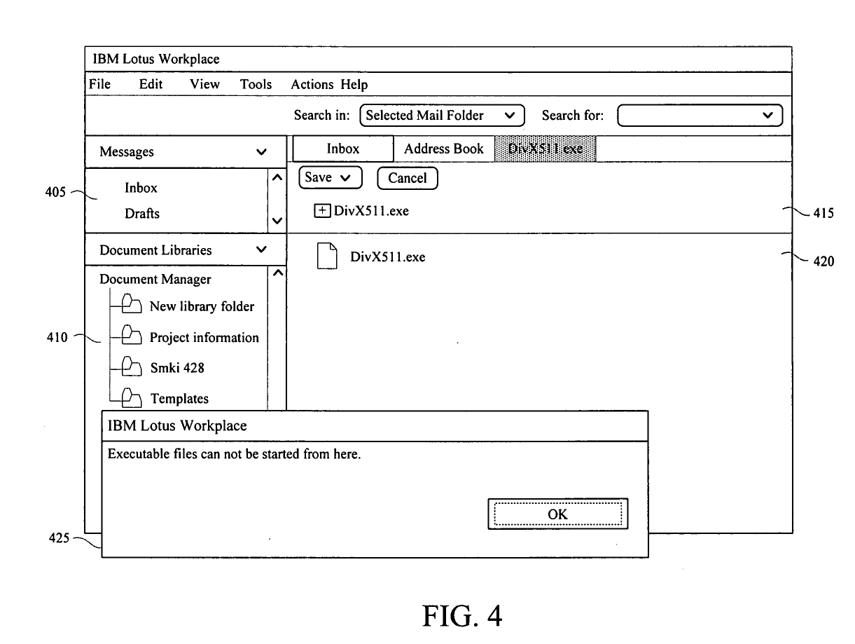

FIG. 4 is a pictorial view of another GUI configured in accordance with the inventive arrangements disclosed herein. The GUI can be used with a document management system or a document management component of a larger distributed, collaborative application. The GUI can include a message navigation window 405 and a document library navigation window 410.

After navigating to and selecting a particular document within document library navigation window 410, relevant information pertaining to the selected document can be shown. The document title and other attributes of the document can be displayed within window 415. Window 420 can display the document itself if considered safe or if unknown and the user has intervened. In this case, the document is an EXE file. Accordingly, a notification 425 has been provided to the user in the form of a pop-up style window informing the user that the selected file type cannot be started from within the application.

The GUIs illustrated within FIGS. 3 and 4 have been provided for purposes of illustration. Accordingly, neither is intended to limit the scope of the present invention. It should be appreciated that any of a variety of different GUI types having various interface elements can be used. Further, audible notification can be provided.

The present invention provides a mechanism for evaluating the safety of documents within a distributed, collaborative application. Based upon a classification of a document being safe, unsafe, or unknown, one or more restrictions can be applied to the handling of the document. The restrictions can be applied within the application, thereby ensuring that any viruses and/or other malicious code is not executed and propagated throughout a shared data store.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of handling electronic documents comprising:
determining at least one safety parameter of an electronic document;
classifying the electronic document based upon the at least one safety parameter;
selecting a restriction policy based upon said classifying step; and
implementing the selected restriction policy for handling the electronic document.

2. The method of claim 1, wherein the electronic document is classified as safe, unsafe, or unknown.

3. The method of claim 1, said classifying step comprising assigning a safe designation to the electronic document such that the restriction policy allows the electronic document to be freely manipulated.

4. The method of claim 1, said classifying step comprising assigning an unsafe designation to the electronic document such that the selected restriction policy prevents the electronic document from being launched.

5. The method of claim 1, said identifying step further comprising determining a file type of the electronic document, wherein if the file type is not known, the electronic document is classified as unknown and the selected restriction policy requires at least one additional user action prior to opening the electronic document.

6. A method of handling electronic documents within a collaborative application comprising:
determining at least one safety parameter of an electronic document;
classifying the electronic document according to said determining step; and
enforcing a security policy based upon a classification of the electronic document.

7. The method of claim 6, wherein a plurality of safety parameters are determined, the plurality of safety parameters comprising a file type for the electronic document, whether the file type has active content, and whether the file type is associated with a security model.

8. The method of claim 7, said classifying step comprising designating the electronic document as safe, unsafe, or unknown.

9. The method of claim 7, said classifying step further comprising designating the electronic document as unknown if the file type is not known.

10. The method of claim 7, said classifying step further comprising designating the electronic document as safe if the file type has no active content or the file type has active content and is associated with a security model.

11. The method of claim 7, said classifying step further comprising designating the electronic document as safe if the file type has active content, the editor used to open the electronic document does not execute active content, and the editor used to open the electronic document can safely process corrupted content.

12. The method of claim 7, said classifying step further comprising designating the electronic document as unsafe if the file type has active content and no security model exists for the file type.

13. The method of claim 7, said classifying step further comprising designating the electronic document as unsafe if the file type has active content and either the editor used to open the electronic document executes active content or the editor used to open the file cannot safely process corrupted content.

14. A machine readable storage, having stored thereon a computer program having a plurality of code sections executable by a machine for causing the machine to perform the steps of:
determining a file type for an electronic document, whether the file type has active content, and whether the file type is associated with a security model;
classifying the electronic document according to said determining step; and
enforcing a security policy based upon a classification of the electronic document.

15. The machine readable storage of claim 14, said classifying step comprising designating the electronic document as safe, unsafe, or unknown.

16. The machine readable storage of claim 14, said classifying step further comprising designating the electronic document as unknown if the file type is not known.

17. The machine readable storage of claim 14, said classifying step further comprising designating the electronic document as safe if the file type has no active content or the file type has active content and is associated with a security model.

18. The machine readable storage of claim 14, said classifying step further comprising designating the electronic document as safe if the file type has active content, the editor used to open the electronic document does not execute active content, and the editor used to open the electronic document can safely process corrupted content.

19. The machine readable storage of claim 14, said classifying step further comprising designating the electronic document as unsafe if the file type has active content and no security model exists for the file type.

20. The machine readable storage of claim 14, said classifying step further comprising designating the electronic document as unsafe if the file type has active content and either the editor used to open the electronic document executes active content or the editor used to open the electronic document cannot safely process corrupted content.
